(19) United States
(12) Patent Application Publication
(10) Pub. No.: US 2010/0332315 A1
(43) Pub. Date: Dec. 30, 2010

(54) GENERATION OF IMPRESSION PLANS FOR PRESENTING AND SEQUENCING ADVERTISEMENT AND SALES OPPORTUNITIES ALONG POTENTIAL ROUTES

(75) Inventors: Semiha Ece Kamar, Providence, RI (US); Eric Horvitz, Kirkland, WA (US); Christopher A. Meek, Kirkland, WA (US); Stephen Lombardi, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/492,861

(22) Filed: Jun. 26, 2009

(51) Int. Cl. G06Q 30/00; G06F 17/10

(52) U.S. Cl. 705/14.46; 705/14.58; 705/14.52

(57) ABSTRACT

A mobile device may present advertisements to users. However, advertisements may be ineffective or dangerous if presented when the attention of the user is unavailable (e.g., while operating a vehicle at a busy intersection.) It may also be desirable to select a sequence of advertisements that interrelate, or that relate the route of the user to an advertised product or service. Therefore, potential routes may be identified (e.g., based on user history or nearby locations of interest), and for potential routes, advertisement opportunities may be identified where the user may have an at least partial attention availability (e.g., traffic signals and fuel stops.) Advertisements may be selected for presentation at the advertisement opportunities of respective potential routes. Additionally, advertisement opportunities may be offered to advertisers in an auction model, and advertisers may specify conditions of advertisements (e.g., competitive placement exclusive of competitors' advertisements, or combinatorial placement of several advertisements.)

### BACKGROUND

Within the field of advertising, a mobile device may present a series of advertisements to one or more users. For example, a set of advertisements may be presented to travelers during a predefined trip, such as on an airplane, train, or bus. These advertisements may be presented on many types of devices (e.g., a display mounted within the vehicle, a handheld device carried by a user, or a speaker that broadcasts audio advertisements within the vehicle.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The presentation of advertisements in a mobile context may be complicated by a few factors. As a first example, in some scenarios, the route of the user (including a set of users, such as several passengers riding in a vehicle) may not be fixed, but may be under the control of the user or another individual. Therefore, it may be difficult to select advertisements that match particular locations, thereby diminishing the achievable value (such as contextual relevance) of the presented advertisements. As a second example, it may be difficult to present advertisements to a user whose attention is variably occupied. In a first such scenario, the user may be controlling the vehicle, and the attention of the user may be wholly available while the vehicle is stopped and the user is simply waiting; partly available while the vehicle is moving, but while the user is not tasked with decision-making; and unavailable while the user is tasked with significant decisions. In a second such scenario, a passenger on a tour may not be receptive to advertisements while the passenger is near an interesting tourist location, but may be receptive to advertisements between such tourist locations.

One technique for improving the selection and presentation of advertisements in mobile contexts with variable routes involves a pre-planned generation of an advertisement plan for potential routes that might be taken by the user. For example, based on various factors (such as the travel history of the user, the current day and time, a starting location of the user detected by global positioning system [GPS], and the user's appointment book), a set of potential routes may be identified, comprising a set of one or more routes that a user might predictably follow at the outset of a trip. Along each potential route, a set of advertisement opportunities may be identified where the user may have an at least partial attention availability. These advertisement opportunities may include, e.g., predicted destinations by the user along the potential route; possible pauses along the route, such as at traffic signals or points of traffic congestion; or periods along the route where the user is not tasked with decision-making, such as a long span of highway travel at a steady speed (such that the user may not be able to devote full attention to an advertisement, but may be able to devote partial attention, e.g., by listening to an audio advertisement while maintaining eye focus on the road.) The advertisement opportunities may therefore be selected to avoid presenting advertisements in inopportune times or locations that may be dangerous (e.g., when the user is likely to be concentrating on navigating a vehicle, such as through a busy intersection) and/or irritating (e.g., when the user is likely to be focusing attention elsewhere, such as a tourist attraction, and may not wish to be interrupted by an advertisement.)

If advertisement opportunities may be identified along potential routes that may be taken by the user and where the user may have an at least partial attention availability, an advertisement plan may be generated, comprising one or more advertisements selected for presentation at particular advertisement opportunities as and if the user travels along the potential route. These advertisements may be selected, e.g., to achieve high advertisement revenue generated by the presented advertisements; to achieve high relevance to the user, such as by targeting the advertisements to traits of the user and/or to the locations of the respective advertisement opportunities; and/or based on the degree of attention that may be available from the user (e.g., a audiovisual advertisement may be displayed for the user during a stop, while an audio-only advertisement may be displayed for the user during highway travel.) As one particular example, high advertisement revenue may be achieved through an auction model, wherein advertisement opportunities may be offered to a set of advertisements associated with one or more advertisement bids, and the advertisements may bid on the advertisement opportunity in various ways.

In addition to generating the advertisement plan, the advertising may involve monitoring actions of the user during the trip, e.g., in order to detect the arrival of the user at various positions corresponding an advertisement opportunity along a potential route in order to display the advertisements selected therefore, or in order to update the advertisement plan with respect to responses received from the user about advertisements (such as the type of advertisements the user responded to or ignored.) The actions of the user may also be monitored in order to determine the response of the user in relation to an advertisement, which may be identified as traits comprising a user profile, whereby subsequent advertisements may be selected that specifically target the user. The user actions may also be monitored to determine the response of the user to particular advertisements, such as a route change to take advantage of an advertisement.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary route having advertisements scheduled at various locations.

FIG. 2 is an illustration of an exemplary advertisement plan of advertisements to be presented at various locations of a route.

FIG. 3 is an illustration of an exemplary route traveled by a set of users and advertisements that may be displayed at various locations according to the advertisement schedule of FIG. 2.

FIG. 4 is an illustration of a set of potential routes identified among a set of locations.

FIG. 5 is an illustration of a set of advertisement opportunities identified along one of the potential routes of FIG. 4.

FIG. 6 is an illustration of a set of advertisements selected to be displayed at the advertisement opportunities identified in FIG. 5.

FIG. 7 is a flow chart illustrating an exemplary method of generating an advertisement plan for a user.

FIG. 8 is a component block diagram illustrating an exemplary system for generating an advertisement plan for a user.

FIG. 9 is an illustration of an exemplary computer-readable medium comprising processor-executable instructions configured to embody one or more of the provisions set forth herein.

FIG. 10 is an illustration of an exemplary user profile comprising a set of completed routes associated with a set of route determinants, and the use of the exemplary user profile in identifying potential routes based on detected route determinants.

FIG. 11 is an illustration of an analysis of travel features in a set of potential routes to identify advertising opportunities along respective potential routes.

FIG. 12 is an illustration of an advertisement plan featuring combinatorial and competitive advertisements.

FIG. 13 is an illustration of an advertisement plan based on a set of probabilities and advertisement bids of various advertisement actions for a particular set of locations along a potential route.

FIG. 14 is an illustration of a predictive function that may be trained to predict various aspects of the techniques discussed herein.

FIG. 15 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Advertisement in mobile contexts may arise in many scenarios. As a first example, passengers in a vehicle (such as a bus, a train, or an airplane) may be presented visual advertisements on a display, or audio advertisements from a speaker or through a set of headphones. As a second example, a user traveling on a vehicle (such as a car, a boat, or a bicycle) or by foot may be presented advertisements from a radio or a handheld visual device. The advertisements may present content to notify the user generally about products or services, and/or may inform the user about locations near the user. In one such scenario, a tourist may be presented advertisements relating to various tourism locations, either generally (e.g., areas of interest within a particular city or geographic area) or in a location-specific manner (e.g., restaurants or tourist spots within a short distance of the current location of the user.) The advertisements presented by various advertisers may therefore result in advertising revenue, which may, e.g., be delivered to the owner of the vehicle (such as the owner of a tour bus); may be delivered to service providers (such as radio stations); may offset hardware or service costs of the advertising device to the user, such as a discount on cellular coverage of a mobile phone operated by the user; or may go directly to the user to whom the advertisements are presented. Moreover, it may be desirable to preselect the advertisements as an advertisement plan, wherein particular advertisements may be presented in a specific order, and/or may be coordinated with particular locations along the route and the interests of users. This may be advantageous, e.g., for promoting the allocation of advertisements in accordance with the conditions and payment terms of advertisers, for improving the contextual relevance of an advertisement to a particular location, and/or for providing personalized advertisement based on the interests of users.

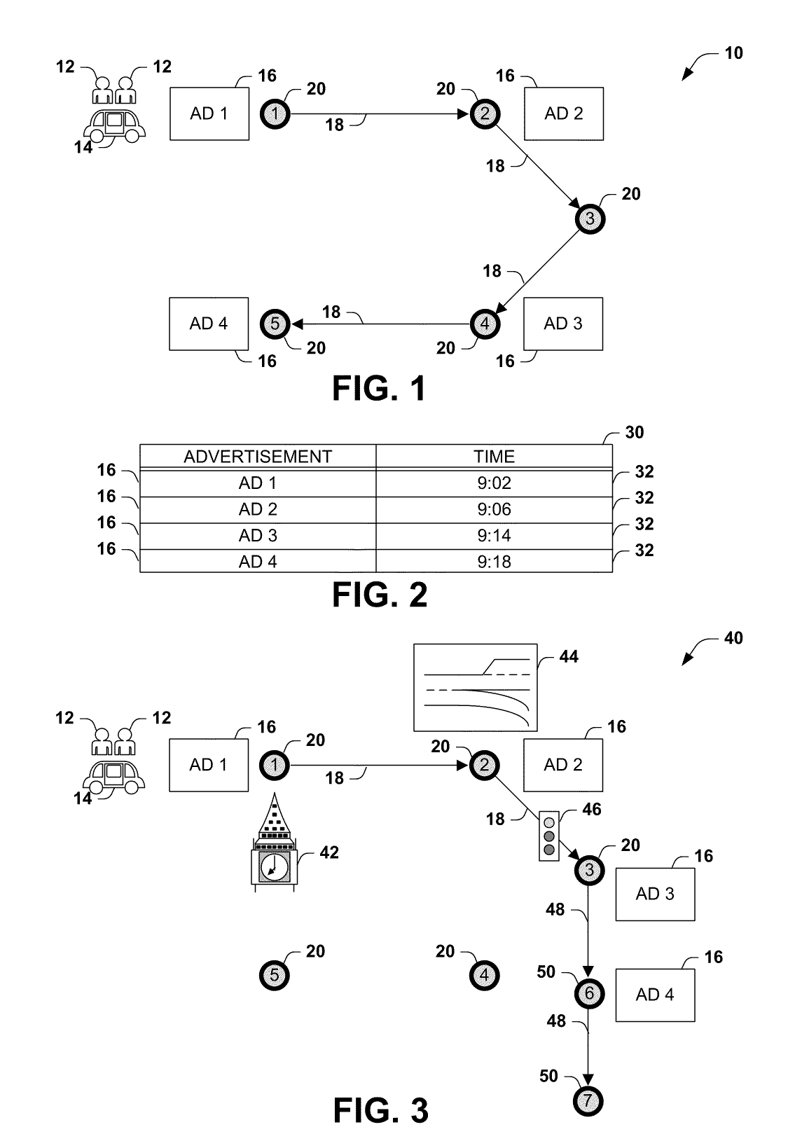

FIG. 1 illustrates an exemplary scenario 10 featuring a presentation of advertisements 16 to one or more users 12 traveling in a vehicle 14. The advertisements 16 may be presented to users in this mobile context, such as on a display mounted within the vehicle 14, over a radio or speaker in the vehicle 14, or on a cellphone device carried by a user 12. The advertisements 16 may be selected in relation to a route 18 connecting a series of locations 20 through which the vehicle 14 is expected to travel (e.g., based on a predesignated route of the vehicle 14, such as a bus or train, or based on a route chosen for the users 12 in order to reach a particular destination, such as the fifth location 20. In particular, when the users 12 are predicted to reach a first location 20, a first advertisement 16 may be displayed; a second advertisement 16 may be displayed when the users 12 are predicted reach a second location 20; a third location 20 may be skipped for advertising; and a third advertisement 16 and a fourth advertisement 16 may be specified, respectively, upon predictably reaching the fourth location 20 and the fifth location 20. This set of advertisements 16 may be selected, e.g., in order to relate the advertisements 16 to particular locations 20, such as relating the third advertisement 16 to the fourth location 20 and relating the fourth advertisement 16 to the fifth location 20. In order to achieve this allocation, an advertisement plan may be devised that specifies the order of presenting the advertisements 16. FIG. 2 illustrates an exemplary advertisement plan 30, illustrated as a table specifying a set of advertisements 16 to be displayed at various times 32. In this simplified example, it may be predicted that each leg of the route 18 may be traversed in four minutes, so the advertisements 16 may be scheduled accordingly.

However, in some mobile contexts, complications may arise if the route of the user is variable. As a first example, a tour guide may allow a tourist to choose among particular tourism destinations, and the route of the user may vary according to the selected tourism destinations. As a second example, the user may be controlling the vehicle, and may opt to take any of several routes to reach particular destinations. As a third example, variations may arise even along a predesignated route, such as road detours or unplanned stops that unexpectedly alter the route, or weather or traffic delays that alter the timing of the route. These complications may interfere with the rendering of advertisements in a pre-planned manner (e.g., as a loop of advertisements that are intended to relate to particular locations along the route.)

In addition, the presentation of advertisements may be complicated by the variable attention of the user. As a first example, a tourist may be occupied during a trip with particular tourism destinations, and may be irritated by an advertisement presented during such a location, but may be more receptive to advertisements presented between tourism locations. As a second example, the user may be operating the vehicle, such as an automobile, and may dedicate attention to the operation of the vehicle in varying degrees. The available attention of the user may therefore vary during the trip; e.g., periods of highly available attention, such as traffic stops and long spans of highway travel, may be interleaved with periods of low or no available attention, such as busy traffic intersections and destinations that are points of interest to the user.

FIG. 3 illustrates another exemplary scenario 40 of users 12 traveling in a vehicle 14 along a route 18, for whom advertisements 16 may be displayed according to the advertisement plan 30 illustrated in FIG. 2. However, as FIG. 3 illustrates, variations that may often arise within the mobile context may cause a mismatch of the route 18 with the advertisements 16 specified in the advertisement plan 30. When the users 12 reach the first location 20, the first advertisement 16 may be presented. However, the first location 20 may comprise a poor location for advertising to the users 12, who may be occupied viewing a landmark 42 at the first location 20, and who may be less receptive (or may altogether ignore) the first advertisement 16. When the users 12 reach the second location 20, the users 12, who may be navigating the vehicle 14, may be occupied dealing with a complicated traffic scenario 44, and the presentation of the second advertisement 16 may serve as an annoying or dangerous distraction to the users 12. On the second leg of the route 18, the users 12 may then encounter a delay, such as a traffic signal 46, which may disrupt the scheduling of the advertisements. For example, if the traffic signal 46 adds four minutes to the schedule, the third advertisement 16 might be displayed at the third location 20 instead of the fourth location 20, and may therefore lose some or all contextual relevance to the location of the users 12. In addition, the traffic signal 46 may represent a missed opportunity to present advertisements to the users 12, whose attention may be fully available. Finally, the users 12 may deviate from the route 18; e.g., after reaching the third location 20, the users 12 may choose an alternate route 48 through the sixth location 50 and the seventh location 50 instead of the fourth location 20 and the fifth location 20. The fourth advertisement 16, which was selected to coordinate with the fifth location 20, may instead be presented at the sixth location 50, again with a partial or total loss of contextual relevance. These types of consequences, which may often arise within context of the mobile advertising, cause a mismatch of the advertisement plan 30 with the route 16 traveled by the users 12, and the presented advertisements 16 may therefore be poorly timed, annoying, dangerous, and/or contextually unrelated to the visited locations, while additional opportunities to advertise to the users 12 may be lost. As a result of these inefficiencies, the advertisers supplying the advertisements 16 may experience diminished advertising revenue, such as sales arising from the displaying of the advertisements 16 to the users 12 and/or diminished advertisement payments provided to the organizers of the advertisement displaying system.

An alternative technique may be developed to generate and utilize an improved advertisement plan 30 that presents advertisements 16 to a user 12 that take into account the complexities of the mobile context, such as route variability, variations in the attention availability of a user 12, and additional advertisement opportunities to present advertisements 16 to the user 12. As a first example, instead of allocating advertisements 16 for a single route 18 that a user 12 is expected to travel, a set of potential routes may be identified. In one such embodiment, these potential routes may be identified based on routes that have previously been completed by the user 12; for example, the location 20 comprising the origin of the user 12 may be detected, and all routes 18 that have previously been completed by the user 12 and having the same origin may be identified as potential routes for the current trip of the user 12. As a second example, for respective routes 18, a set of advertisement opportunities may be identified where one or more advertisements 16 may be presented. These advertisement opportunities might include locations, e.g., selected stops along the route 16, but may also include, e.g., positions along the route 16 where part or all of the attention of the user 12 may be available, such as a traffic signal, a point of traffic congestion, or a particular portion of the route 16 where the user 12 might travel at a steady speed and with few decision-making opportunities, such as a long span of highway travel. The possible routes and advertisement opportunities may be assigned a probability that reflects the likelihood of coming true. It may be possible to identify portions of each potential route where the attention of the user 12 may be highly available, may be only partially available, or may not be available for receiving an advertisement. For example, an accessible map might indicate traffic signals, areas of typical traffic congestion, and the comparative difficulty of navigating a particular portion of the potential route, and sensors might detect current traffic patterns and construction delays. Therefore, for respective potential routes, a set of advertisement opportunities may be identified, corresponding to the predicted attention availability of the user 12. As a third example, one or more advertisements 16 may be selected from a set of advertisements for the advertisement opportunities identified along the identified potential routes. These advertisements may be selected in various ways, e.g., to maximize the advertising revenue generated by displaying the advertisements 16 along a potential route, to maximize the targeting and contextual relevance of the selected advertisements 16 in view of the user 12 and the route 16.

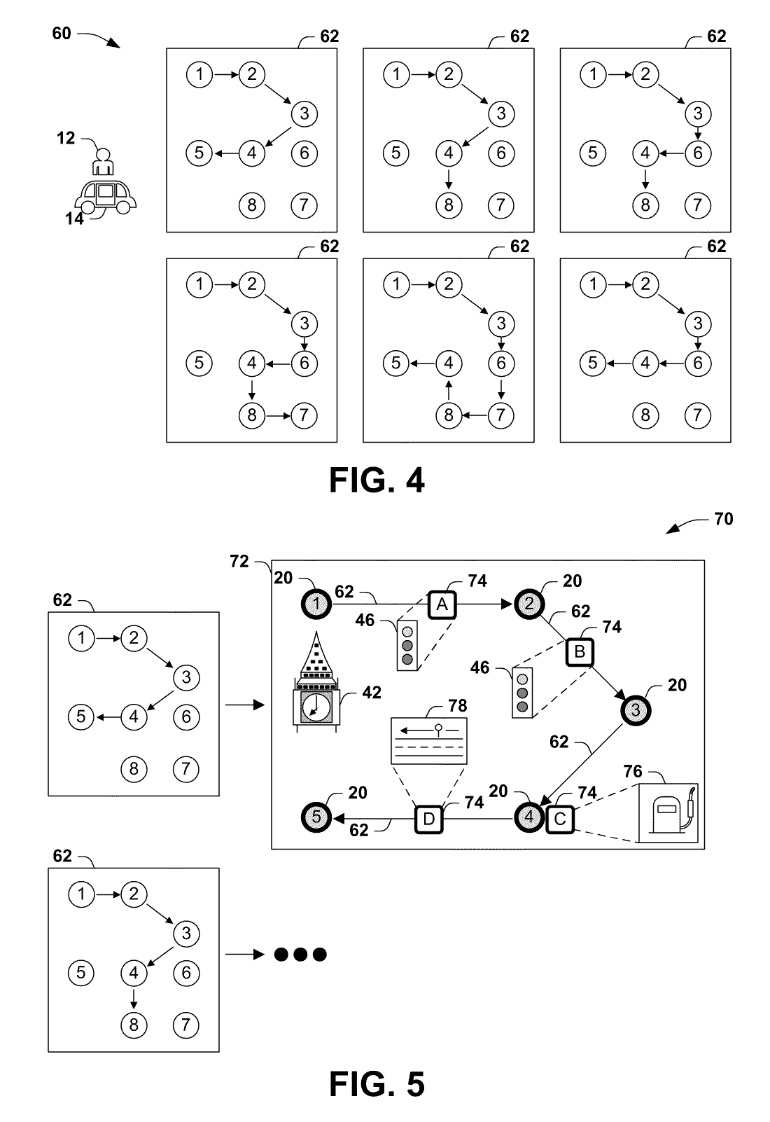

FIGS. 4 through 6 together present an exemplary embodiment of these techniques. FIG. 4 presents an exemplary scenario 60 illustrating a potential route set 64, comprising a selection of potential routes 62 that may be taken by a user 12, e.g., while controlling a vehicle 14. A set of potential routes 62 may be identified, comprising routes 18 that the user 12 may take while traveling. The potential routes 62 may be identified in many ways. As a first example, travel history of the user 12 may be recorded comprising the completed routes of the user 12 over a period of time. The potential routes 62 may therefore map to the completed routes by the user 12, such as if the user 12 repeats a route 18 that has previously been taken. As a second example, an origin of the user 12 may be detected, e.g., via a global positioning system (GPS) receiver, and a set of potential routes 62 may be identified involving routes that the user 12 might be inclined to take to and among nearby destinations. As a third example, the user 12 may have designated an interest in visiting a set of destinations, and potential routes 62 may be identified among various combinations and subcombinations of such destinations.

For respective potential routes 62, a set of advertising opportunities may be identified. FIG. 5 presents an exemplary scenario 70 illustrating an identification of an advertising opportunity set 72, involving advertising opportunities 74 that might arise along the potential route 62. While such advertising opportunities 74 might or might not arise if the user 12 travels the potential route 62 (e.g., a traffic signal at which the user 12 may stop for a while or may pass through without stopping), the advertising opportunities 74 might be selected in case such an opportunity does arise. For example, and as illustrated in FIG. 5, a first advertising opportunity 74 might arise at a first traffic signal 46 located between a first location 20 and a second location 20 along the potential route 62. (It may be noted that an advertising opportunity might not be selected for the first location 20, which may be a landmark 42 where the user 12 may not wish to be distracted by an advertisement 16.) A second advertising opportunity 74 might arise at a second traffic signal 46 located between the second location 20 and a third location 20 along the potential route 62. A third advertising opportunity 74 might arise at a fourth location 20, e.g., a fuel stop 76, and a fourth advertising opportunity 74 might arise at a long highway span 78, where the user 12 might travel in the vehicle 14 at a steady speed and with few navigation decisions to be made, thereby leaving a portion of the attention of the user 12 available. These advertising opportunities 74 may be identified for this potential route 62, as well as the other potential routes 62 identified in FIG. 4, to produce an advertising opportunity set 72 for each potential route 62.

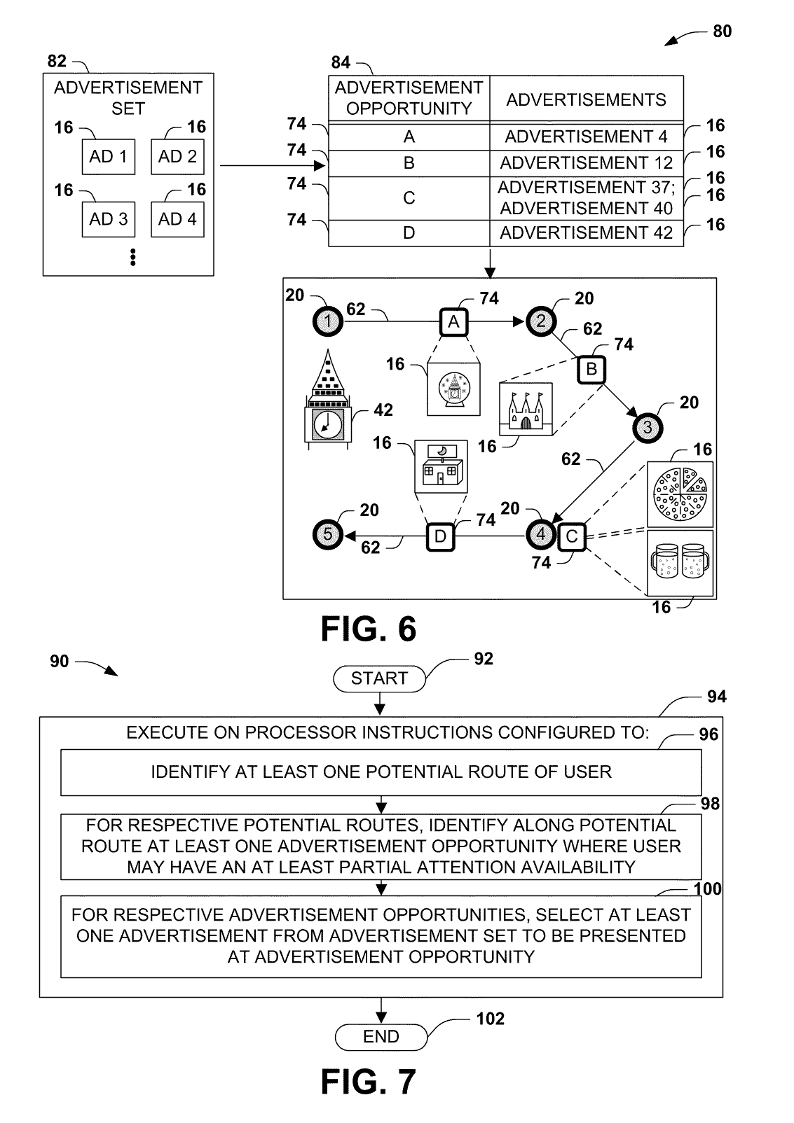

For the respective advertising opportunities 74 along the potential routes 62, one or more advertisements 16 may then be selected. FIG. 6 illustrates an exemplary selection of advertisements 16 for the advertising opportunities 74 identified for the potential route 62 in FIG. 5, wherein advertisements 16 are selected from an advertisement set 82 to be presented to the user 12 at various advertisement opportunities 74. A first advertisement 16 may be selected to be presented at the first advertisement opportunity 74 (e.g., a souvenir of the landmark 42 recently visited at the first location 20.) A second advertisement 16 may be selected to be presented at the second advertisement opportunity 74 (e.g., a second landmark 16 that may be visited at the sixth location 60 if the user 12 wishes to make a detour upon reaching the third location 20.) At the third advertising opportunity 74 presented at the third location 20 (the fuel stop), a third advertisement 16 and a fourth advertisement 16 may be selected for presentation that advertise nearby restaurants serving food and beverages; these advertisements 16 might be presented concurrently, in random or ordered series, etc. A fifth advertisement 20 may be selected to be presented at the fourth advertisement opportunity 74 (e.g., a hostel positioned along the long highway span 78 in case the user 12 wishes to rest.) Advertisements 16 may be similarly selected for the advertising opportunities 74 identified along the other potential routes 62, thereby comprising an advertising plan 84. This advertising plan 84 may be used in conjunction with the advertisement set 82 to present a predesignated set of advertisements 16 if the user 12 chooses to any of the potential routes 62. Moreover, the advertisements 16 may be generated in a holistic manner (i.e., as a complete set of advertisements 16 that may be displayed along the potential route 62), and the advertisements 16 may be presented in a manner compatible with the attention availability of the user 12.

FIG. 7 presents a first exemplary embodiment of the techniques discussed herein, comprising an exemplary method 90 of generating an advertisement plan 84 for a user 12. The exemplary method 90 might be implemented, e.g., as a set of software instructions configured for execution by a computer having a processor and having access to an advertisement set 82. The exemplary method 90 begins at 92 and involves executing 94 instructions upon the processor that are configured to perform the techniques discussed herein. In particular, the exemplary instructions are configured to identify 96 at least one potential route 62 of the user 12 (e.g., as per the exemplary scenario 60 of FIG. 4); for respective potential routes 62, to identify 98 along the potential route 62 at least one advertisement opportunity 74 where the user 12 may have an at least partial attention availability; and for respective advertisement opportunities 74, select 100 at least one advertisement 16 from the advertisement set 82 to be presented at the advertisement opportunity 74. In this manner, the exemplary method 90 achieves a generation of the advertising plan 82 to be used during the travel of the user 12 along a selected potential route 62, and so ends at 102.

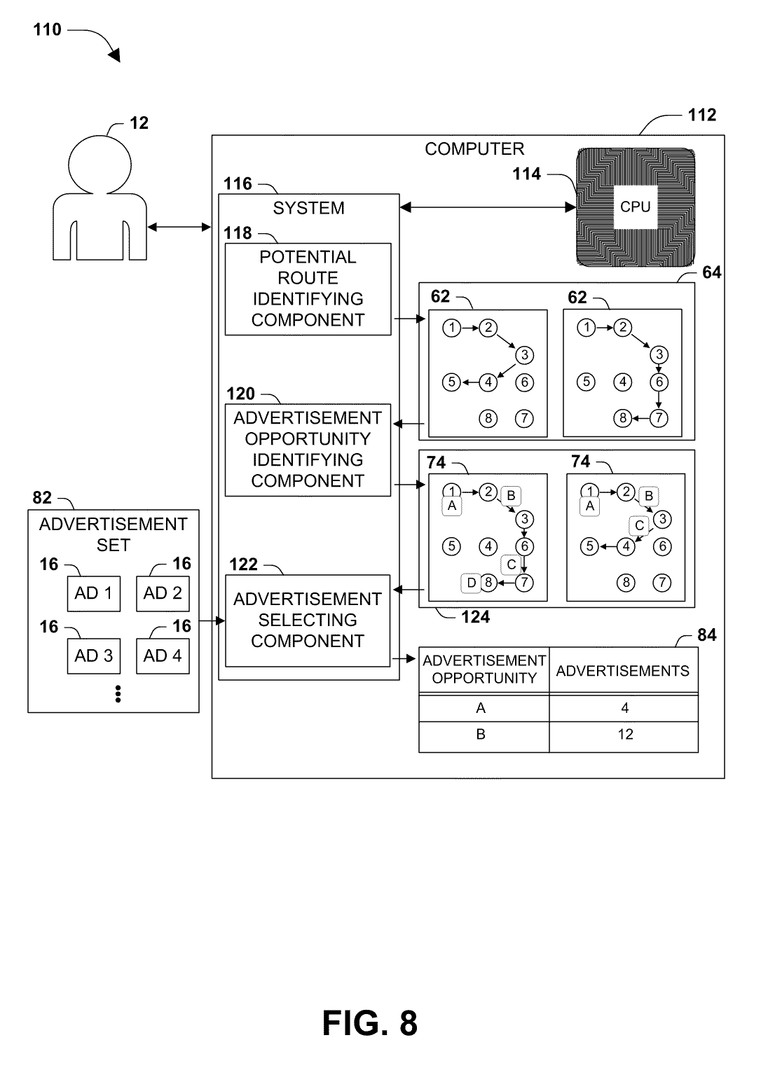

FIG. 8 presents a second embodiment of the techniques presented herein, comprising an exemplary system 116 configured to generate an advertisement plan 84 for a user 12 of a computer 112 having access to an advertisement set 82. The computer 112 may comprise, e.g., a nonmobile device, such as a workstation or server, or a mobile device, such as a notebook, palmtop, or cellphone; and may be located with the user 12 on a route 18 or in a different location; etc. The computer 112 comprises a processor 114 configured to service the exemplary system 116 (e.g., by executing instructions comprising a software implementation of the exemplary system 116) and has access to an advertisement set 82 (which may, e.g., be stored in the computer 112, or may be accessible to the computer 112 over a network.) The exemplary scenario 110 comprises a potential route identifying component 118, which is configured to identify at least one potential route 62 of the user 12, such as by generating a potential route set 64. The exemplary system 116 also comprises an advertisement opportunity identifying component 120, which may be configured to, for respective potential routes 62, identify along the potential route 62 at least one advertisement opportunity 74 where the user 12 may have an at least partial attention availability, thereby generating a potential route set 124 including advertisement opportunities 74 identified along each potential route 62. The exemplary system 116 also comprises an advertisement selecting component 122, which may be configured to, for respective advertisement opportunities 74 of the respective potential routes 62, select at least one advertisement 16 from the advertisement set 82 to be presented at the advertisement opportunity 74. The exemplary system 116 thereby achieves the generation of the advertisement plan 84, which may be used in conjunction with the advertisement set 82 to present advertisements 16 while the user 12 travels along one of the potential routes 62.

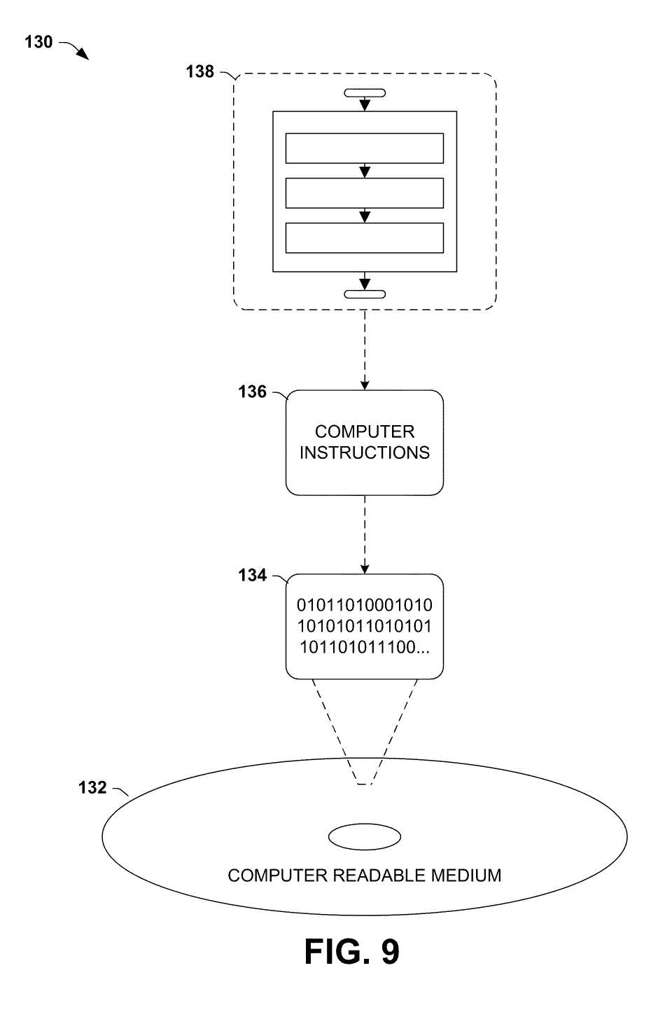

Still another embodiment involves a computer-readable medium comprising processor-executable instructions configured to apply the techniques presented herein. An exemplary computer-readable medium that may be devised in these ways is illustrated in FIG. 9, wherein the implementation 130 comprises a computer-readable medium 132 (e.g., a CD-R, DVD-R, or a platter of a hard disk drive), on which is encoded computer-readable data 134. This computer-readable data 134 in turn comprises a set of computer instructions 136 configured to operate according to the principles set forth herein. In one such embodiment, the processor-executable instructions 136 may be configured to perform a method of generating an advertisement plan for a user, such as the exemplary method 90 of FIG. 7. In another such embodiment, the processor-executable instructions 136 may be configured to implement a system for generating an advertisement plan for a user, such as the exemplary system 116 of FIG. 8. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 90 of FIG. 7 and the exemplary system 116 of FIG. 8) to confer individual and/or synergistic advantages upon such embodiments.

A first aspect that may vary among embodiments of these techniques relates to the identification of the potential routes 62 of the user 12. As a first variation, the potential routes 62 may be identified by first identifying the origin of the user 12 (e.g., the point at which the user may begin traveling), selecting a set of nearby locations (e.g., locations in which the user 12 has expressed an interest in visiting, or locations that users often like to visit, such as popular tourist attractions), and generating a set of potential routes 62 thereamong. The potential route set 64 may also be filtered, e.g., by eliminating or assigning lower probability or priority to a less efficient or more problematic potential route 62, and/or by assigning higher probability or priority to a potential route 62 that is often selected or traveled.

As a second variation of this first aspect, information about the user 12 may be used to identify potential routes 62 that might be traveled by the user 12, and where the user 12 may have an at least partial attention availability. As a first example, an embodiment of these techniques (e.g., the exemplary system 116 of FIG. 8) may, over time, monitor the user 12 to determine a completed route that the user 12 selects and completed on a particular trip. The embodiment may then store a route record in a user profile (which may be stored, e.g., in the volatile or non-volatile memory of the computer 112), where the route record specifies the completed route. Finally, the embodiment may use the route records stored in the user profile to identify potential routes 62 of the user by selecting at least one completed route specified in at least one respective route record of the user profile. In this manner, the history of the user 12 may be used as the basis for the identification of the potential routes 62. Alternatively or additionally, the identification of potential routes 62 may involve detecting a set of route determinants that may be predictive of the route 18 selected by the user 12. For example, an embodiment of these techniques may detect the identity and status of the user 12 (e.g., a first user 12 may respond more favorably to a particular set of potential routes, while a second user 12 may respond more favorably to a partially or wholly different set of potential routes); some route-determining information about the user 12 (e.g., an appointment book that indicates the days and times of intended destinations of the user 12); and/or the identity or status of the environment (e.g., the day of the week, the current time, the current weather or traffic patterns, or the status of a vehicle, such as the fuel level or maintenance log.) After detecting one or more route determinants, the embodiment may then identify potential routes 62 that are correlated with the one or more route determinants.

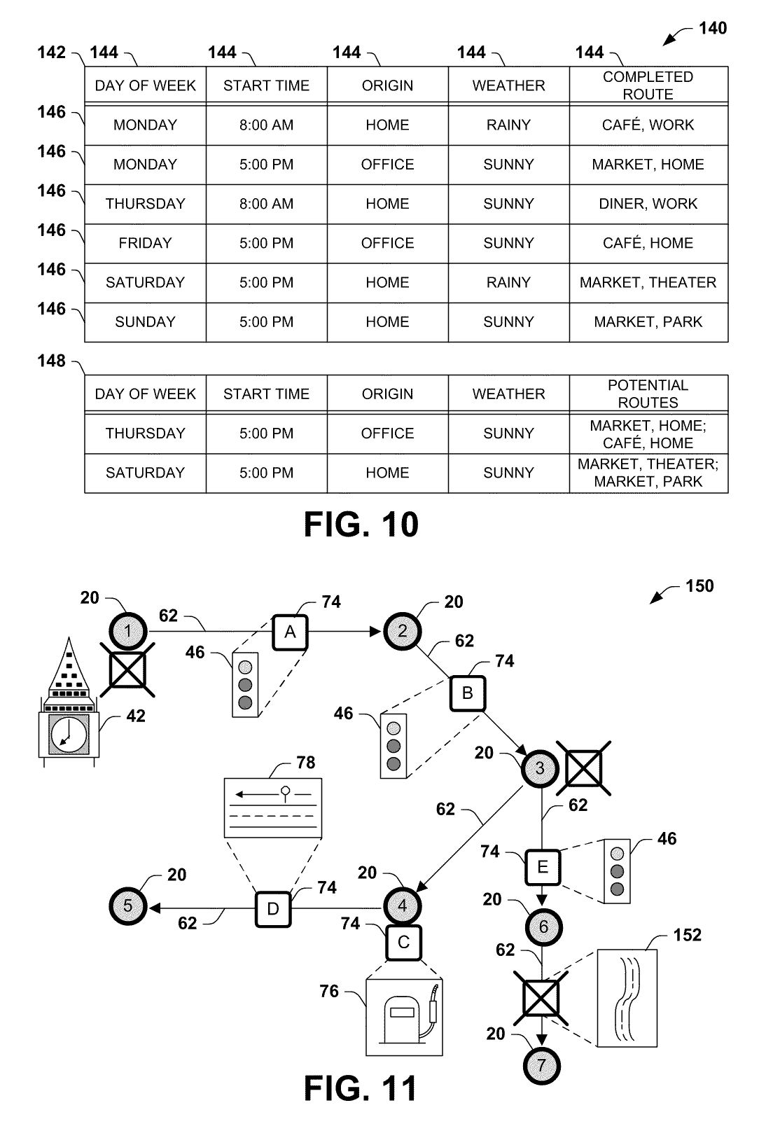

FIG. 10 illustrates an exemplary scenario 140 featuring a synergistic combination of these variations to identify potential routes 62 of a user 12 based on a user profile 142. The user profile 142 comprises route records 146 identifying particular completed routes that the user 12 has traversed in the past. Each route record 146 includes a recorded set of route determinants 144 detected during the completed route, including the day of the week and the start time of the completed route (detected via a clock); an origin of the completed route (detected via a global positioning service [GPS] receiver); and the weather occurring during the completed route (detected by a weather monitoring device.) Respective route records 144 also identify the locations 20 comprising the completed route, such as two locations visited along the completed route. The user profile 142 may be used to identify potential routes 62 at the beginning of a new travel instance by the user 12 by first detecting the current route determinants 144, and then by referring to the user profile 142. As a first example, if the current route determinants 144 indicate that the user 12 is initiating travel on a Thursday at 5:00 P.M., starting from the office of the user 12 on a sunny day, these route determinants 144 may be correlated with the route determinants 144 detected in the route record 146 to identify potential routes 62 as traveling to home by way of the market (as per a similar route record 146 occurring on a Monday), or as traveling to home by way of the cafe (as per a similar route record 146 occurring on a Friday.) As a second example, if the current route determinants 144 indicate that the user 12 is initiating travel on a Saturday at 5:00 P.M., starting from the home of the user 12 on a sunny day, the potential routes 62 may be identified as visiting the theater after visiting the market (as per a similar record on a rainy Saturday) or as visiting the park after visiting the market (as per a similar record on a sunny Sunday.) The exemplary scenario 140 therefore illustrates one technique for identifying potential routes 62; however, those of ordinary skill in the art may devise many ways of identifying potential routes while implementing the techniques discussed herein.

A second aspect that may vary among embodiments of these techniques relates to the identification of advertisement opportunities 74 along a particular potential route 62. As a first variation, advertisement opportunities 74 may be identified by requesting the user 12 to indicate when the user 12 may be receptive to an advertisement 16, or by monitoring biometrics of the user 12 (e.g., eye movements) to determine when the user 12 may have available attention. These detected advertisement opportunities 74 may then be associated with the completed route, or with locations along the completed route, and may subsequently be used to identify advertisement opportunities 74 along a potential route 62 that is equivalent to a completed route, or that includes the locations where such advertisement opportunities 74 were identified.

As a second variation of this second aspect, advertisement opportunities 74 may be identified by analyzing travel features along one or more potential routes 62, such as locations with many or few decisions that may identify a probability that the user 12 may have an at least partial attention availability. For example, advertisement opportunities 74 may be identified based on traffic signals where the user 12 may have to wait; road features that may consume more or less attention of the user 12 (e.g., tight chicanes that involve careful attention vs. long highway spans where the user 12 may travel in a straight line and at a comparatively steady speed); and the nature of different locations 20 along the potential route 62 (e.g., a tourist site where a user 12 may not wish to be interrupted with an advertisement 16 vs. a fuel stop where a user 12 may be receptive to one or more advertisements 16.) Moreover, respective advertisement opportunities 74 may be identified as positions along a potential route 62 having a significant probability of an attention availability of the user 12 at the position. For example, at a traffic signal 46 mediating traffic through a busy intersection, the user 12 might have an attention availability if the traffic signal 46 compels the user 12 to wait, or might not have an attention availability if the user 12 does not have to wait at the traffic signal 46 and may be attending to crossing the busy intersection. Because the probability that the user 12 may have an attention availability is significantly high, the traffic signal 46 may be selected as an advertisement opportunity 74 along any potential route 62 incorporating the position of the traffic signal 46. If the user 12 later selects to follow one such potential route 62, advertisements 16 might be displayed at the advertisement opportunity 74 only if the user 12 actually has an attention availability upon arriving at the position (e.g., only if the traffic signal 46 compels the user 12 to wait), and may otherwise postpone or cancel the presenting of such advertisements 16.

FIG. 11 illustrates an exemplary scenario 150 wherein advertisement opportunities 74 may be identified at positions along two potential routes 62, the first potential route 62 involving the first through fifth locations 20, and the second potential route 62 involving the first through third locations 20 and the sixth and seventh locations 20. In view of these potential routes 62, advertisement opportunities 74 may be identified at a first traffic signal 46 located between the first location 20 and the second location 20; at a third traffic signal 46 located between the second location 20 and the third location 20; and at a third traffic signal 46 located between the third location 20 and the sixth location 20. Additional advertisement opportunities 74 may be identified at the fourth location 20 comprising a fuel stop 76, where the user 12 may stop to refuel, and at a long highway span 78, where the user 12 may have a partial attention availability. Conversely, advertisement opportunities might not be identified at locations where the attention availability of the user 12 is likely to be low or zero, e.g., at the first location 20 near the landmark 42; at the third location 20, where the user 12 might choose between the first potential route 62 and the second potential route 62; and at a position featuring a difficult road condition, such as narrow or tight curves 152 that may be comparatively difficult to navigate in safety. By implementing this type of analysis, an embodiment of these techniques may identify advertisement opportunities 74 along potential routes 62 based on the corresponding attention availability of the user 12 in view of these and other travel features.

As a third variation of this second aspect, in addition to being identified as an advertisement opportunity 74, different positions along a potential route 62 may be associated with different attention types of the user 12. As a first example, one advertisement opportunity 74 may be identified as a comparatively short period of attention availability of the user 12 (e.g., at a traffic signal 46), while another advertisement opportunity 74 may be identified as a comparatively long period of attention availability of the user 12 (e.g., at a fuel stop 76.) As a second example, at one advertisement opportunity 74, the entire attention of the user 12 may be available (e.g., at the fuel stop 76), while at another advertisement opportunity 74, only partial attention of the user 12 may be available (e.g., while traveling on the long highway span 78 at a steady speed.) Accordingly, advertisements 16 may be selected to be presented at the advertisement opportunity that are compatible with the attention type of the user 12 associated with the position along the potential route 62. For example, longer advertisements 16 may be selected for presentation during comparatively longer advertisement opportunities 20, while shorter advertisements 16 may be selected for presentation during comparatively short advertisement opportunities 20. Similarly, at advertisement opportunities 74 associated with total attention availability of the user 12, interactive or video advertisements 16 may be presented to the user 12, while at advertisement opportunities 74 associated with only partial attention availability of the user 12, the advertisements 16 selected for presentation may be limited to audio-only advertisements or static images. Those of ordinary skill in the art may devise many ways of identifying advertisement opportunities 74 along the identified potential routes 62 of the user 12 while implementing the techniques discussed herein.

A third aspect that may vary among embodiments of these techniques relates to the selection of advertisements 16 to be presented upon reaching an advertisement opportunity 74 along a potential route 62. As a first variation of this third aspect, the advertisements 16 may be stored and accessed in many ways in accordance with these techniques. As a first example, the advertisement set 82 may be locally stored on a computer 112 (such as a mobile device) in a database. As a second example, the advertisement set 82 may be remotely stored, and may be accessed by the computer 112 via a communications device, such as a cellular adapter that may receive advertisements 16 delivered over a cellular network or the internet. As a third example, the advertisements 16 might be provided to the computer 112 over a localized connection; e.g., advertisers might deliver advertisements 16 to the computer 112 over a Bluetooth connection when the computer 112 is within range of the advertiser, and the computer 112 might incorporate these advertisements 16 in the advertisement plan 30.

Additional variations of this third aspect relate to the many ways that may be devised of selecting advertisements 16 in the advertisement set 82 for respective advertisement opportunities 74 for respective the potential routes 62 to create an advertisement plan 84. As a second variation of this third aspect, advertisements 16 may be selected arbitrarily to fill the advertisement opportunities 74. For example, advertisements 16 may be chosen in random order, with one advertisement 16 allocated to each advertisement opportunity 74 in order to promote an even distribution of the frequencies with which the advertisements 16 of the advertisement set 82 may be presented to the user 12.

As a third variation of this third aspect, advertisements 16 comprising an advertisement plan 84 may be selected in view of the other advertisements 16 that may or may not be included in the same advertisement plan 84. In such embodiments, the selecting of advertisements 16 may involve selecting a first advertisement 16 to be presented at a first advertisement opportunity 74, where the first advertisement 16 relates to a second advertisement 16 that is to be presented at an advertisement opportunity 74. As a first example, a first advertisement 16 may be selected in competition with a second advertisement 16; e.g., for a location having several restaurants, several food advertisements 16 may be presented to provide several options to the user 12. Alternatively, a first advertisement 16 may be selected exclusively of a second advertisement 16; e.g., an advertiser may condition a payment for a presentation of an advertisement 16 only if no competing advertisements 16 are presented for the same advertisement opportunity 74. As a second example, a first advertisement 16 may be selected that features a product or service that is related to a product or service featured in a second advertisement 16 at the same advertisement opportunity 74. For example, and as illustrated relating to the third advertisement opportunity 74 of FIG. 6, a set of complementary products or services may be advertised together in advertisements (either concurrently or sequentially) presented at the same advertisement opportunity 74. As a third example, for an advertisement opportunity 74, a first advertisement 16 featuring a product or service may be selected that relates to a second advertisement 16, selected for presentation at an earlier or later advertisement opportunity 74, that features the same product or service or a related product or service. For example, a first advertisement 16 for a product may presented that reiterates or continues an advertisement for the same product that was presented at an earlier advertisement opportunity 74. As a fourth example, a first advertisement 16 may be selected for at an advertisement opportunity 74 that may arise if the user 12 performs a particular advertisement action at an earlier advertisement opportunity 74 that involved a presentation of a second advertisement 16 to which the first advertisement 16 is related. For example, if the user 12 chooses to alter a previously intended route in order to take advantage of a second advertisement 16, a first advertisement may be presented at an advertisement opportunity 74 arising along the new route that relates to the second advertisement 16, e.g., by advertising a related or complementary product or service.

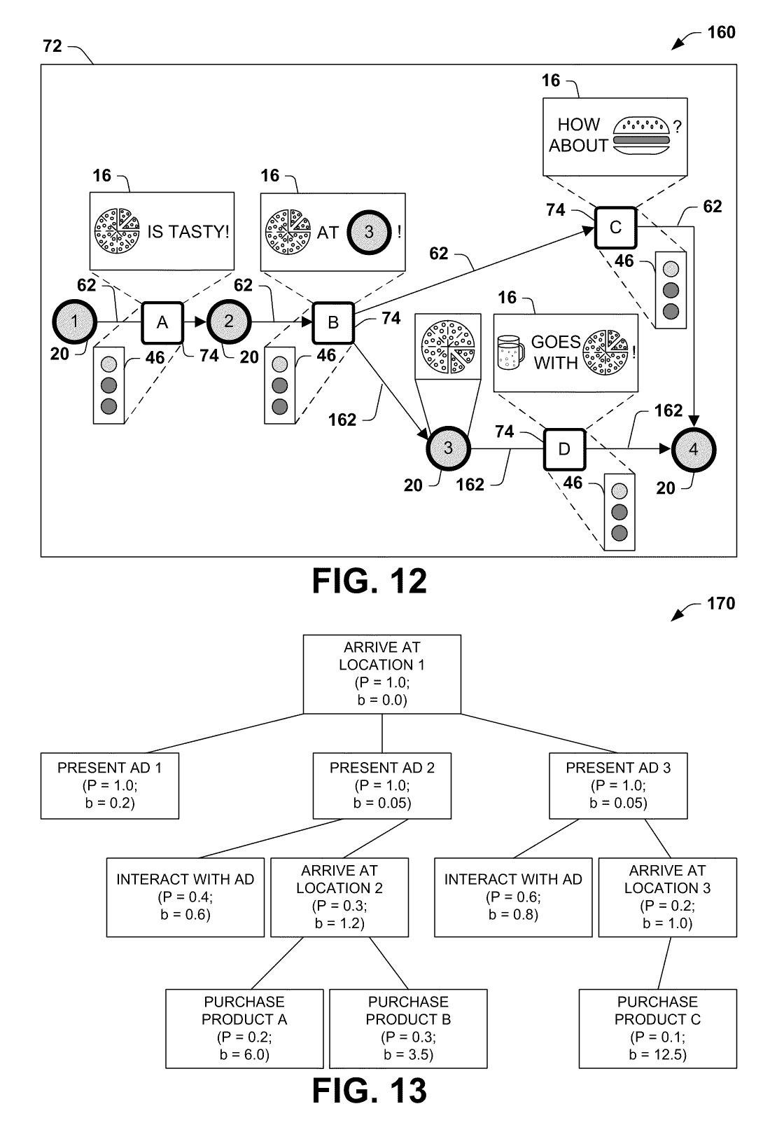

FIG. 12 presents an exemplary scenario 160 featuring a selection of advertisements 16 for various advertisement opportunities 74 in an advertisement opportunity set 72 relating to a particular potential route 62. While the potential route 62 of the user 12 may involve an arrival at a fourth location 20, a restaurant a third location 20 near the potential route 62 may be available that serves a particular type of food. In order to advertise for the restaurant, advertisements 16 may be selected for the advertisement plan 84 at advertisement opportunities 20 leading up to an opportunity to change the course to the third location 20 where the restaurant is located. For example, at a first advertisement opportunity 74 (e.g., a traffic signal 46), a first advertisement 16 may be selected for presentation that suggests the type of food in the abstract, without any mention of the third location 20, in order to plant an idea in the mind of the user 12 relating to the advertised type of food. Subsequently, at a second advertisement opportunity 74 (e.g., another traffic signal 46), a second advertisement 16 may be selected for presentation that indicates the imminent availability of the type of food at the third location 20. If the user 12 continues along the potential route 62 toward the fourth location 20, it may be presumed that the user 12 is not interested in the advertised type of food or the restaurant. Therefore, at a third advertisement opportunity 74, a third advertisement 16 may be selected for an alternative type of food that may be available at a different restaurant near the potential route 62. The third advertisement 16 is therefore related to the opportunity declined by the user 12 to select the food advertised by the first advertisement 16 and the second advertisement 16. Alternatively, the user 12 may divert to the third location 20 and visits the restaurant, it may be presumed that the user 12 has chosen to accept the advertised food. Therefore, a second potential route 162 toward the fourth location 20 may be identified that begins at the first location 20 but that diverts through the third location 20 before continuing to the fourth location 20. Therefore, at a fourth advertisement opportunity 74 along the second potential route 162 (which may be the same as the third advertisement opportunity 74, such as the same traffic signal 46, or may be a different advertisement opportunity 74 at a different location), a fourth advertisement 16 may be presented for a complementary product (e.g., a type of drink that goes well with the type of food that the user 12 may have consumed at the third location 20.) The fourth advertisement 16 is therefore selected to relate to the first advertisement 16 and the second advertisement 16 that are to be presented to the user 12 at earlier advertisement opportunities 74.

As a fourth variation of this third aspect, an advertisement opportunity 74 may be associated with at least one advertisement opportunity factor, which may relate the advertisement opportunity 74 to one or more advertisements 16. An advertisement opportunity factor may therefore render these advertisements 16 particularly relevant, and these advertisements 16 may be selected for presentation at the associated advertisement opportunity 74. As a first example, an advertisement opportunity factor may comprise a location-based association of the advertisement opportunity 74 with one or more advertisements 16, such as restaurants near the location where the advertisement opportunity 74 has been positioned along a potential route 62. As a second example, an advertisement opportunity factor may relate to the duration of a potential route at the position of the advertisement opportunity 74; e.g., a user 12 may be compelled to stop for food, fuel, or rest at a convenient position along the potential route 62 coinciding with an advertisement opportunity 74. As a third example, an advertisement opportunity factor may relate to an estimate of the probable duration of each advertisement opportunity 74, and a series of one or more advertisements 16 may be selected to maximize the use of the estimated duration of the advertisement opportunity 74. As a fourth example, an advertisement opportunity factor may relate to an attention type may be identified for a particular advertisement opportunity 74 (e.g., partial or whole attention availability of the user 12, or an interactive or non-interactive attention availability of the user 12.) Advertisements 16 may therefore be selected that are compatible with the attention type that is likely to be exhibited by the user 12 during the advertisement opportunity 74 (e.g., a partial, non-interactive attention type may correspond to audio-only or static image advertisements 16, while a total, interactive attention type might correspond to video advertisements 16 or advertisements 16 with a user interface component.)

As a fifth variation of this third aspect, advertisements 16 may be selected for an advertisement opportunity 74 based on the predicted user relevance of the advertisements 16 to the user 12 if presented at the advertisement opportunity 74. This may be desirable, e.g., in order to promote the perceived utility of the advertising system to the user 12, who may be more likely to devote attention to presented advertisements 16 if selected to be of relevance to the user 12. Conversely, if the user 12 perceives the advertisements 16 to present little or no user relevance, the user 12 may be inclined to disregard future presentations of advertisements 16, thereby reducing the value and effectiveness of the advertising.

As a first example, various traits of the user 12 may be detected or recorded, e.g., in a user profile 142, and may be utilized in according to targeted advertising principles. One embodiment of this first example might be configured to identify at least one trait of the user 12, such as a demographic fact about the user 12; a profession, hobby, or interest of the user 12; a product or service preference of the user 12 (depending on the context; time of day, day of week, previous responses, etc.); a positive or negative response of the user 12 to a prior advertisement 72; or a purchase of a product or service by the user 12. Alternatively, rather than detecting the traits of the user 12, the embodiment may simply ask the user to input some traits upon which advertisements 16 may be based, e.g., a set of favorite food types. Based on these traits of the user 12, the embodiment may be configured to select advertisements 16 targeted to the user 12 based on the at least one trait (e.g., by selecting advertisements 16 for restaurants that specialize in preparing and offering the types of food preferred by the user 12.)

As a second example, the user relevance of the advertisements 16 to the user 12 may be predicted based on the nature of the potential route 62, such as the motivations of the user 12 in selecting the potential route 62. For example, a first potential route 62 may include the office of the user 12 as a final destination, while a second potential route 62 may include a recreational park near the user 12 as a final destination. It may be inferred that if the user 12 chooses the first potential route 62, the user 12 may only wish to receive advertisements 16 relating to the profession of the user 12 or to the start of a work day (e.g., a cafe where coffee may be obtained.) Additionally, it may be inferred that the user 12 may only wish to receive a few advertisements 16, as the user 12 may be preoccupied with workday plans or may be on a tight schedule. Alternatively, if the user 12 chooses the second potential route 62, the user 12 may be more interested in recreational or leisure activities, such as shopping at a store or visiting a theater, and may be receptive of more advertisements 16 due to a more lax schedule. Therefore, the selection of advertisements 16 for particular advertisement opportunities 74 may be related to the characteristics of the potential route 62, and advertisements 16 may be selected to fill advertisement opportunities 74 according to the inferred or stated motivations of the user 12.

Additional variations of this third aspect may relate to the advertisement payment that may be provided by an advertiser in exchange for serving the advertisement 16 to the user 12. This advertisement payment might be provided upon different actions relating to the advertisement 16 (e.g., upon presenting the advertisement 16 to a user 12; upon the user 12 interacting with the advertisement 16; upon the user 12 taking some action relating to the advertisement 16, such as selecting a new route 18 to visit a destination featured in the advertisement 16; or purchasing a product or service featured in the advertisement 16.) The advertisement payment may, e.g., be paid directly to the user 12; may offset some service costs that might otherwise be charged to the user 12 (e.g., as a discount on cellular service for a cellphone device on which the advertisements 16 are presented); may be paid to the provider of a service (such as cellular service), to a provider of a mobile device to the user 12, or to a provider of a vehicle 14 occupied by the user 12; etc. Moreover, the advertisement payments associated with some advertisements 16 may be higher or lower than the advertisement payments associated with other advertisements 16 by the same advertiser or by other advertisers. In view of these scenarios, some variations of the third aspect may involve a selection of advertisements 16 might be devised to achieve high advertising revenue for the advertisements 16 rendered along each potential route 62. For example, if the advertisements 16 in an advertisement set 82 have an advertisement action that is associated with an advertisement payment, an embodiment of these techniques may be configured to select advertisements 16 for respective advertisement opportunities 74 such that, for each potential routes 62, maximize the advertisement payments associated with the advertisement actions of the advertisements.

A sixth variation of this third aspect, devised in accordance with the selection of advertisements 16 to achieve high advertisement payments, involves an auction model for matching advertisements 16 with advertising opportunities 74. For example, for a particular advertising opportunity 74, respective advertisements may have an advertisement bid. The selection of advertisements 16 may therefore be devised to maximize advertisement payments for respective potential routes 62 by offering respective advertisement opportunities 74 along the potential route 62 to the advertisements 16, by receiving an advertisement bid from respective advertisements 16 for the advertisement opportunity 74, and selecting the advertisement 16 offering the high advertisement bid for the advertisement opportunity 74. As the user 12 travels and selects one of the potential routes 62, the advertisements 16 may be displayed at the advertisement opportunities 74 along the route 18, and the advertisement bids of the displayed advertisements 16 may be tabulated and charged to the respective advertisers.

The specification and selection of advertisement bids for respective advertisements 16 may be achieved in many ways. As a first example, an advertiser may specify the advertisement bid as metadata associated with the advertisement 16. As a second example, the advertiser may simply offer the advertisement 16 as part of the advertisement set 82, and may issue an ad hoc advertisement bid upon being notified of the advertisement opportunity 74. As a third example, the advertisement 16 may be provided by the advertiser with an advertisement bidding logic, such as a mobile agent, which may be devised by the advertiser and executed (e.g., by a computer 112 implementing the auction model for selecting advertisements 16) to compute the advertisement bid of the advertisement 16. Moreover, an advertisement 16 might specify one or more advertisement bids associated with an advertisement action; e.g., a first advertising bid might be offered for presenting the advertisement 16, a second advertising bid might be offered for an interaction of the user 12 with the advertisement 16, and a third advertisement bid might be offered for a route change or additional stop along the potential route 62 by the user 12 in response to the advertisement 16.

These examples might compute or specify the advertisement bid of the advertisement 16 based on a variety of advertising conditions, such as one or more traits of the user 12 that might correlate with the content of the advertisement 16; a user relevance 166 of the user 12 having a predicted correlation with the advertisement 16; the attention type of the user 12 that may be available at the advertisement opportunity 74; and/or advertisement opportunity factors that might relate the advertisement 16 to the advertisement opportunity 74. Other advertising conditions might relate to advertisements 16 selected for other advertisement opportunities 74 along the potential route 62. A competitive advertising condition might condition an advertising bid on the selection (including non-selection) of other advertisements 16 for other advertising opportunities 74 in the advertisement plan 84 (e.g., an advertising bid for a restaurant might be conditioned on the non-selection of advertisements 16 for competing restaurants in the same advertisement opportunity 74, in the same potential route 62, or in the entire advertisement plan 84.) A combinatorial advertising condition might condition an advertising bid on the co-selection of advertisements 16 (for the same product or service or for a different product or service, and/or by the same advertiser or by other advertisers) for at least two advertisement opportunities in the advertisement plan 84 (e.g., an advertising bid might specify the selection of a set of advertisements 16 for the same product to be displayed in a consecutive series of advertisement opportunities 74, such as in the Burma-Shave advertisement technique.) In these and other scenarios, the advertising bids of the advertisements 16 may be specified, computed, and/or evaluated in various ways in the auction model of selecting advertisements 16 for respective advertisement opportunities 74 of a potential route 62.

However, if a potentially large advertisement set 82 comprising many advertisements 16 are to be selected for a potentially large number of advertisement opportunities 74 in a potentially large number of potential routes 62, wherein each advertisement 16 may involve various advertisement conditions and/or may offer various advertisement bids for different advertising actions, maximizing the advertisement payments along the respective potential routes 62 may be computationally intensive. Moreover, such predictions are further complicated by the predicted probabilities that the user 12, upon being presented with an opportunity to take an advertisement action (e.g., interacting with an advertisement 16, performing a route change to take advantage of an advertisement 16, or purchasing a product or service presented in an advertisement 16.) These computations may also account for the future expected value if the user 12 undertakes a particular advertisement action. As a first example, if the user 12 chooses to travel to a particular restaurant presented in a particular advertisement 16, the user might forego visiting other locations 20 where other advertisements 16 might be presented, and where other advertisement actions might be undertaken, that may result in a higher advertisement payment. As a second example, a first advertisement 16 may offer a high advertisement bid for the advertisement action of presenting the first advertisement 16, but the user 12 might be unlikely to respond with further advertisement actions (such as a route change or a purchase of the product or service) that result in additional advertisement payments. It might therefore be desirable to select instead a second advertisement offering a lower advertisement bid for the advertisement action of presenting the second advertisement 16, if the user 12 is more likely to respond with further advertisement actions that result in additional advertisement payments.

Various computational techniques may be devised to achieve a maximum (or at least suitably high) advertisement payments predicted for various potential routes 62. One such technique may be based on a Markov Decision Process (MDP), wherein, for a particular state in a potential route 62 (such as arriving at a location 20 or an advertisement opportunity 74 arising), the set of available advertisement actions for that state might be conceptualized as a tree, having at its root the advertisement opportunity and branches representing the advertisement actions that might be available if the root advertisement action corresponding to the advertisement opportunity is undertaken. Moreover, each such advertisement action might be computed together with the associated advertisement bid offered by the respective advertiser for undertaking the advertisement action, as well as a predicted probability that the user 16 might undertake the advertisement action. In some embodiments, the tree may be expanded, or additional trees generated, that branch into future advertisement opportunities and actions based on previously reached advertisement opportunities and previously completed advertisement actions. The computed value of the advertisement action might also include the expected future advertisement payments may be computed for the following advertisement actions that might be available after the user 12 undertakes the advertisement action, and such future advertisement payments might be discounted in view of the diminished probability of performing the advertisement action in the future.

FIG. 13 illustrates an exemplary scenario 170 featuring a portion of a Markov Decision Process, modeled as a tree of advertising actions that may be undertaken by a user 12. The root state in the tree represents the arrival of the user 12 at a particular location 20 in a potential route 62 that represents an advertisement opportunity 74, and the children of the root state represent the advertisement actions that may be taken at this advertisement opportunity 74. It may be appreciated that this tree illustrates only a small set of advertisements 16 that may be presented at a few advertisement opportunities 74 along one potential route 62, and that many other trees may be devised that together comprise the advertisement plan 30 covering all such potential routes 62 and advertisement opportunities 74 therealong (e.g., the root of the tree represents the departure location.) Alternatively, the breadth of such trees may vary among embodiments of these techniques; e.g., a first embodiment may involve generating a set of comparatively small trees, such as trees respectively representing advertisement opportunities 74; a second embodiment may involve generating one large tree representing the entire advertisement plan 30; and a third embodiment may involve generating a small initial tree to represent a first few predicted routes and/or advertisement opportunities, but the breadth of the tree and/or additional trees may be generated as the user 12 travels and selects particular routes. This continuous generation may, e.g., advantageously distribute the computation involved in predicting the potential routes and advertisement opportunities across the duration of the user's travel. Additionally, the processing may be efficiently allocated by allocating computational resources to more probable routes and/or more valuable advertisement opportunities before evaluating less probable routes and/or less valuable advertisement opportunities.

In the exemplary scenario 170 of FIG. 13, the advertisement actions comprising the illustrated portion of the Markov Decision Process are exclusive; e.g., the advertisement opportunity 74 may be of a short duration, and only one advertisement 16 may be selected for presenting. Moreover, these and following advertisement actions are illustrated with both a probability (P) of the user 12 undertaking the advertisement action, and an expected advertisement bid (b) for the completion of the advertisement action. For example, the children of the root action all involve presenting the respective advertisements 16, which may be certain to complete (as the probabilistic behavior of the user 12 is not involved), but with different advertisement bids. For example, the first advertisement 16 might offer a comparatively high advertisement bid (b=0.2) for presenting the first advertisement 16, but might not offer any subsequent advertisement actions that might result in future expected payments if this state is selected. By contrast, presenting either the second advertisement 14 or the third advertisement 14 afford a possibility of subsequent advertising actions that might result in expected future advertisement payments from the respective advertisers. Therefore, choosing among the comparative values of the states that are available for selection at the root state (i.e., the advertisement payments that might result from the selection of different advertisements 16 for the advertisement opportunity 74) might involve computing not only the value and probability of the child state, but also the expected future advertisement payments that might result from subsequent advertisement actions. The value of such subsequent advertisement actions might in turn be computed, e.g., based on the probability that the user 12 might undertake such advertisement actions; the advertisement bid associated with the advertisement action; and a discounting factor in view of the compounded uncertainty of reaching the state through one or more intermediate states.

This technique may be applied to select among advertisements 16 for an advertisement opportunity 74 of a potential route 62 by considering, in turn, the advertisement bid of the advertisement action of the advertisement 16, the probability that the user 12 might undertake the advertisement action, and the expected future advertisement payment arising from further advertisement actions. This computation may be performed according to the mathematical formula:

V*(s)=max_{a∈A(s)}R(s,a)+Σ_{s′}T(s′,s,a)×V*(s′)

wherein:

s represents a state in a potential route corresponding to at least one of an advertisement opportunity and a location (which may also include information about the history, e.g., the advertisements shown before and user responses, and the destination of the user);

S represents a state set comprising the states s in the potential route;

V*(s) represents an expected cumulative value of state s, comprising expected advertisement revenue for the advertisement opportunity and future opportunities following state s;

A(s) represents a set of advertising actions for respective advertisements at a state s;

R(s,a) represents revenue for displaying an advertisement a at state s;

s′ represents a second state in a potential route that is accessible from a state s;

V*(s′) represents an expected cumulative value of state s′; and

T(s′,s,a) represents a transition probability of transitioning from a state s to a state s′ upon performing an advertising action a. (This probability may include, e.g., a likelihood of the user selecting a route containing state s, a likelihood of the user performing an advertisement action that result in state s, and/or a likelihood of the user having an appropriate cognitive load that allow advertisement opportunity at state s.)

By computing expected cumulative advertisement payments of respective advertisement actions according to this mathematical formula, an embodiment of these techniques might select advertisements 16 for respective advertisement opportunities 74 that generate a desirably high advertisement payment.

A fourth aspect that may vary among embodiments of these techniques relates to the formulation of various predictive aspects (e.g., the probabilities of potential routes 62, the availability of advertisement opportunities 74, and the responsiveness of the user 12 to particular advertisements 16.) For example, a computer embodying these techniques may utilize a predictive function that has been specially trained to predict potential routes 62, to identify advertisement opportunities 74 and the attention availability of the user 12 at such advertisement opportunities 74, and/or to select advertisements 16 having a predicted high user responsiveness of the user 12 during the advertisement opportunity 74 (e.g., a purchase of an advertised product or service; a detected route change that may be associated with an advertised product or service, such as an advertised restaurant; or an interaction with the advertisement 16, such as a user-submitted request for additional information about the advertised good or service.) It may be desirable to configure an embodiment of these techniques (e.g., the computer 112 of FIG. 8) to compute these predictions based on available information and various machine learning techniques in order to provide more prescient predictions, more efficient allocation of computing resources, and/or the selection of a higher-value advertisement plan 30.

Many machine learning techniques (and combinations thereof) may be utilized in this capacity, such as a Bayesian network classifier, Support Vector Machine, logistic regression, and neural network models. These predictive functions may also be developed based on a training data set, which may present historic and/or heuristic information on which such predictions may be based. The training data set may include, e.g., a user profile comprising information specific to a particular user 12, such as the historic route selection of the user 12, the availability of the user 12 at a previously visited advertisement opportunities 74 or at similar advertisement opportunities 74 (e.g., the attention availability of the user 12 at traffic stops of a particular duration), and the responsiveness of the user 12 to particular advertisements 16. The user profile may also include contextual information that may be relevant to such predictions, such as the predicted actions of the user 12 in view of the weekday or time, the status of the user 12 (e.g., the likelihood of the user 12 to stop for food and stretching during a long trip), and the presence or absence of other users 12 (e.g., a user 12 may be more likely to select a first set of potential routes 62 when the user 12 is alone, and a second set of potential routes 62 when the user 12 is traveling with a particular passenger.)

Many embodiments of these techniques may utilize an additional data source that may facilitate the predicted actions of the user 12. As a first example, the user profile may include demographic information about the user 12, which may be correlated with actions based on the actions of other users 12 who share one or more demographic traits with the user 12 (e.g., the type of car driven by the user 12, or the statistically determined demographics of individuals starting at the starting location of the route of the user 12.) As a second example, the user 12 may utilize a source of location and navigation data (such as a geolocation, mapping, and/or routing service or device) in selecting the route, and the service may be able to provide information that facilitates a more accurate prediction of routes; e.g., the user 12 may have requested routes to a particular location or having certain properties, and the provision of these routes to the user 12 may be used to predict the potential routes 62 of the user 12. As a third example, a geolocation, mapping, and/or routing service or device may compile a route profile representing predicted user actions (such as route selection and advertisement responsiveness) in view of a current route, a current location, recently visited locations, or the preceding route of a trip. This route profile may be used to predict the actions of the user 12 during the completion of a similar route; e.g., if this user 12 or other users 12 of a similar demographic often follow a particular potential route 62 after visiting a set of locations on a route, a current user 12 having visited the same set of locations may be predicted as more likely to follow the same potential route 62. As a fourth example, an advertising profile may be utilized that represents the responsiveness of various users 12 to one or more advertisements 16, and this advertising profile may be utilized by a predictive algorithm to select advertisements 16 for particular advertisement opportunities 74 to which the user 12 is likely to respond favorably, based on the demographics of the user 12. As a fifth example, the training data set might not be based on a user profile, but may be an aggregate collection of responses by any user to an advertisement 16 (e.g., routes that are predictably followed by any user 12, or the population-wide responsiveness of users 12 to a particular advertisement 16) or in selecting a particular potential route 62.

Once the predictive function is sufficiently trained to predict various aspects of these techniques, the predictive function may be utilized to compute more accurate predictions about the potential routes 62, the advertisement opportunities 74 along the potential routes 62, and/or the selection of advertisements 16 for advertisement opportunities 74 that have a high user relevance. In this manner, patterns of consumer interest may be tracked and predicted in order to select advertisements 16 having significant user relevance to the user 12 when presented at a particular advertisement opportunity 74. Moreover, the training data set may be supplemented with additional information (e.g., by monitoring and evaluating the actions of the user 12), and the training of the predictive function may continue during the use of these techniques to render more prescient predictions of various aspects in future travels of the user 12.

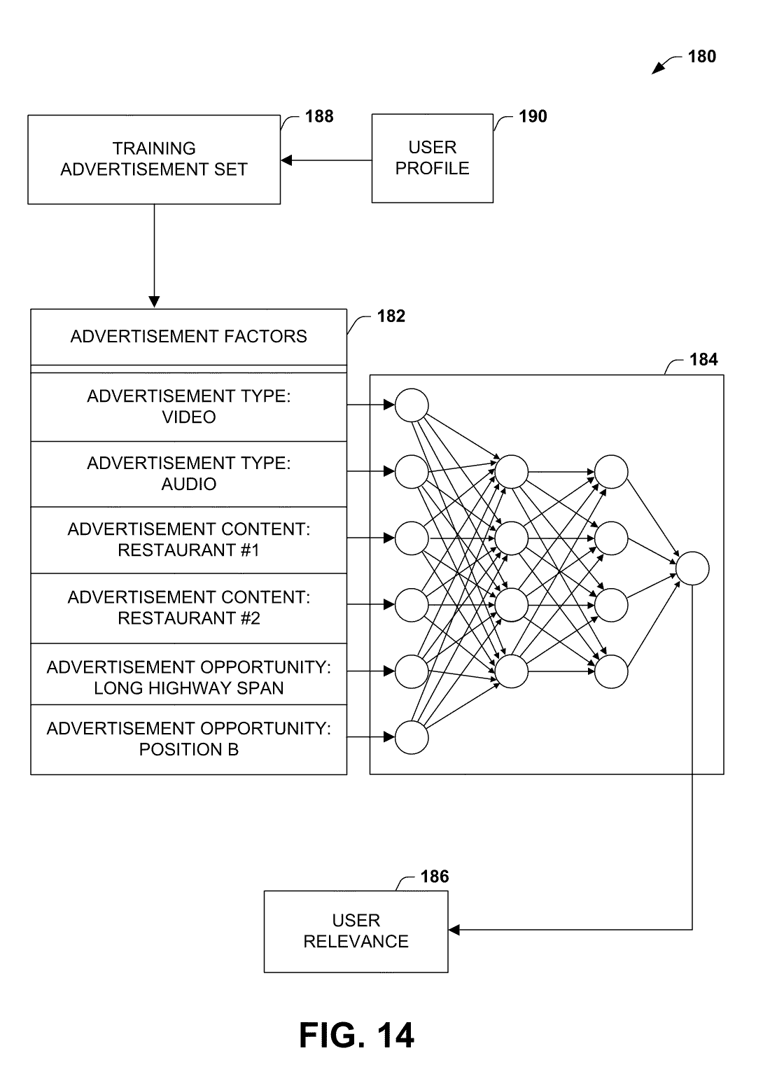

FIG. 14 illustrates an exemplary scenario 180 featuring a predictive function 184 embodied as a Bayesian network, which may be trained, in particular, to predict a user relevance 186 of a particular advertisement 16. The predictive function 184 may be trained using a training advertisement set 188, e.g., a set of advertisements that have been presented to users 12 at particular advertisement opportunities 74 and the resulting responses of the users 12, comprising a positive response (e.g., a route change pursuant to the advertisement 16 or an interaction of the user 12 with the advertisement 16) that is suggestive of a higher user relevance 186 or a negative response (e.g., no detected response by the user 12 to the advertisement 16) that is suggestive of a lower user relevance 186. The training advertisement set 188 may be based, e.g., on a user profile 190 of a particular user 12 of the exemplary system 116. The advertisements 16 of the training advertisement set 168 may be evaluated (e.g., by a Bayesian network classifier or other statistical classification model) to identify a set of advertisement factors 182 associated with the presentation of an advertisement 16 at an advertisement opportunity 74. These advertisement factors 182 of the advertisement 16 and the resulting responses of the users 12 may be used to train the predictive function 184 to identify correlations that may be predictive of the user relevance 186 of a particular advertisement 16 to users 12 when presented at a particular advertisement opportunity 74.

When the predictive function 184 of FIG. 14 has been sufficiently trained to produce acceptably accurate predictions of user relevance 186, the predictive function 184 may be utilized (e.g., by a computer 112 utilizing an embodiment of these techniques) to select advertisements 16 for particular advertisement opportunities 74 that result in desirably high levels of user relevance 186. In a more sophisticated embodiment, the predictive function 164 may produce a set of user relevances 186 for a particular advertisement 16, each relating to a different user profile 190, and a user profile 190 of a user 16 of the exemplary system 116 might be utilized to select the user relevance 186 of the user profile 190 that matches the user 16. If several advertisements 16 are predicted to be of acceptably high relevance to the user 12, the advertisements 16 may be selected for presentation in series at the advertisement opportunity 74 (within the predicted duration of the advertisement opportunity 74.) Conversely, if no advertisement 16 is found to be of acceptable user relevance 186, the advertisements 16 may be withheld from the advertisement opportunity 74 to mitigate a dilution of the attention availability of the user 12, and the advertisement opportunity 74 might be removed altogether from the potential route 62. In this manner, the exemplary scenario 180 of FIG. 14 illustrates the selection of advertisements 16 based on the predicted user relevance 186 of the advertisement 16 to the user 12. However, those of ordinary skill in the art may devise many predictive aspects based on machine learning principles while implementing the techniques discussed herein.

A fifth aspect that may vary among embodiments of these techniques relates to additional features that may be included with the aspects and/or embodiments. These features may be included to provide additional advantages (individually and/or synergistically) and/or to reduce disadvantages in such embodiments. As a first variation of this fifth aspect, embodiments of these techniques may be configured to present the advertisements 16 while user 12 travels along at least one potential route 62. For example, an embodiment may monitor the user 12 (e.g., the vehicle 14 in which the user 12 is traveling) to determine a selected route 18 among the potential routes 62, and to determine an arrival at an advertisement opportunity 74 along the selected route 18; and when such an arrival is detected, the embodiment may present the advertisements 16 to the user 12 that have been selected for presentation at the advertisement opportunity 74. For example, the computer 112 may include a display or a speaker, and upon detecting the arrival of the user 12 at an advertisement opportunity 74 (e.g., if the computer 112 detects by a global positioning service [GPS] device that the user 12 has stopped at a traffic signal 46), the computer 112 may identify the advertisements 16 that have been selected for presentation at this advertisement opportunity 74, retrieve the selected advertisements 16 from the advertisement set 82, and present the selected advertisements 16 to the user 12.

As a second variation of this fifth aspect, an embodiment may be configured to monitor the user 12 to detect various advertisement actions. For example, the embodiment may detect that the user 12 is examining the presented advertisement 16 (e.g., by tracking the eye movements of a user 12 who is looking at or reading a visual advertisement 16); that the user 12 is interacting with the advertisement 16 (e.g., by operating a touch device, such as a touchscreen or a mouse, to request more information about an advertised good or service); that the user 12 is performing a route change 18 in response to the advertisement 16; or that the user 12 is purchasing or has purchased an advertised good or service. The detection of such advertisement actions may permit the computer 112 to assist the user 12 in regard to the advertisement 16, e.g., by providing additional information about an advertised good or service, such as a coupon; by presenting related advertisements 16 to the user 12; or by programming a mapping device, such as a global positioning service receiver, to facilitate the user 12 in arriving at a location 20 relating to the advertisement 16, such as an advertised restaurant. Alternatively or additionally, the embodiment may monitor the user 12 to detect advertisement actions wherefrom traits of the user 12 may be identified. These traits might be stored in the user profile of the user 12, such as by recording one or more traits that describe the interests of the user 12 about the advertised goods or services. The newly stored traits might be useful, e.g., in selecting additional advertisements 16 with improved user relevance to the user 12; in predicting a probable response of the user 12 to future advertisements 16; and/or in identifying potential routes 62 that the user 12 may take in the future.

As a third variation of this fifth aspect, an embodiments of these techniques might also facilitate the tabulation of advertisement payments earned through the presenting of advertisements 16 to the user 12. If the advertisements 16 are submitted by advertisers who offer an advertisement payment for such presentation, the advertisement payments may be tabulated by the computer 112 to be charged to the advertiser. For example, as advertisements 16 are presented, an advertisement payment associated with the advertisements 16 may be computed that is to be paid by the advertiser. If the advertisement payment is conditioned upon an advertisement action (e.g., a route change performed by the user 12), an embodiment may detect the advertisement action, and may compute the advertisement payment to be paid for the advertisement 12 upon detecting the advertisement action. The computed advertisement payment may, e.g., be stored in a database of the computer 112 that may later be used to request and receive advertisement payments from the associated advertisers. Alternatively or additionally, the computer 112 may more actively participate in the reception of advertisement payments, such as by charging the advertisement payment to the advertiser (e.g., by transmitting to the advertiser a notification of the presentation of the advertisement 16 and the associated advertisement payment accruing thereby.)

One technique for computing the advertisement payment may involve a consideration of the predicted probability that the user 12 might perform an advertisement action. This computation may be based on many factors. As a first example, if an advertiser submits an advertisement bid to be paid upon a presentation of an advertisement 16 to the user 12, the advertiser may have a reliable expectation of the advertisement payments that are likely to accrue, based on the selection of advertisements 16 for advertisement opportunities 74 according to the techniques presented herein. However, if the advertiser submits an advertisement bid that is conditioned upon an advertisement action to be performed by the user 12, the advertiser may be unable to predict the advertisement payments that might accrue, since the probability of the performance of the advertisement actions by the user 12 is uncertain. As a second example, the advertisement payment may be based, e.g., on the expected future value of subsequent advertisement actions associated with the advertisement 16, and/or upon the value of other advertisement opportunities 74 that might be foregone once the user 12 takes the advertisement action. The advertisement payment may therefore be adjusted to include not only the value to the advertiser in the advertisement action so performed by the user 12, but also the value to the advertiser in the opportunity for further advertisement actions that might now be available to the user 12 regarding the advertisement 16, and the value to the advertiser in excluding other advertisements 16 (e.g., by competing advertisers) that might not be available once the user 12 performs the advertisement action.

In view of these considerations, upon detecting an advertisement action related to an advertisement 16, an advertisement payment that is collected from advertiser i at state ss may be computed according to the mathematical formula:

$${T}_{i} ( s , b ) = \frac{{V}_{- i}^{*} ( s , {b}_{- i} ) - {V}_{- i}^{*} ( s , {b}_{- i} \vert {π}^{*} ( s , b ) )}{{P}_{action} ( {b}_{i} )}$$

wherein:

s represents a state in a potential route corresponding to at least one of an advertisement opportunity and a location;

bᵢ represents an advertising bid received from advertiser i;

π*(s,b) represents a selected advertisement action computed for state s that maximizes the cumulative expected value in view of bids bb;

V*₋ᵢ(s,b₋ᵢ) represents the cumulative expected value of all advertisers except advertiser i in state s, when advertiser i is excluded from advertisement opportunities (i.e., the cumulative expected value when advertiser i is removed from consideration this advertisement opportunity and for all future opportunities);

V*₋ᵢ(s,b₋ᵢ|π*(s,b)) represents a cumulative expected value of all advertisers except advertiser i state s if the selected advertisement action is selected for the advertisement opportunity (this optimal action may belong to advertiser i), and if advertiser i is excluded from future advertisement opportunities;

P_{action}(bᵢ) represents a probability that the user will undertake the action associated with bᵢ; and

Tᵢ(s,b) represents an advertisement payment to be collected from advertiser i at state s.

By computing the advertising payment in this manner, the embodiment may more fully compute the value to the advertiser in the presentation of the advertisement 16 to the user 12, and may charge and receive an advertisement payment that more accurately reflects and captures this value.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

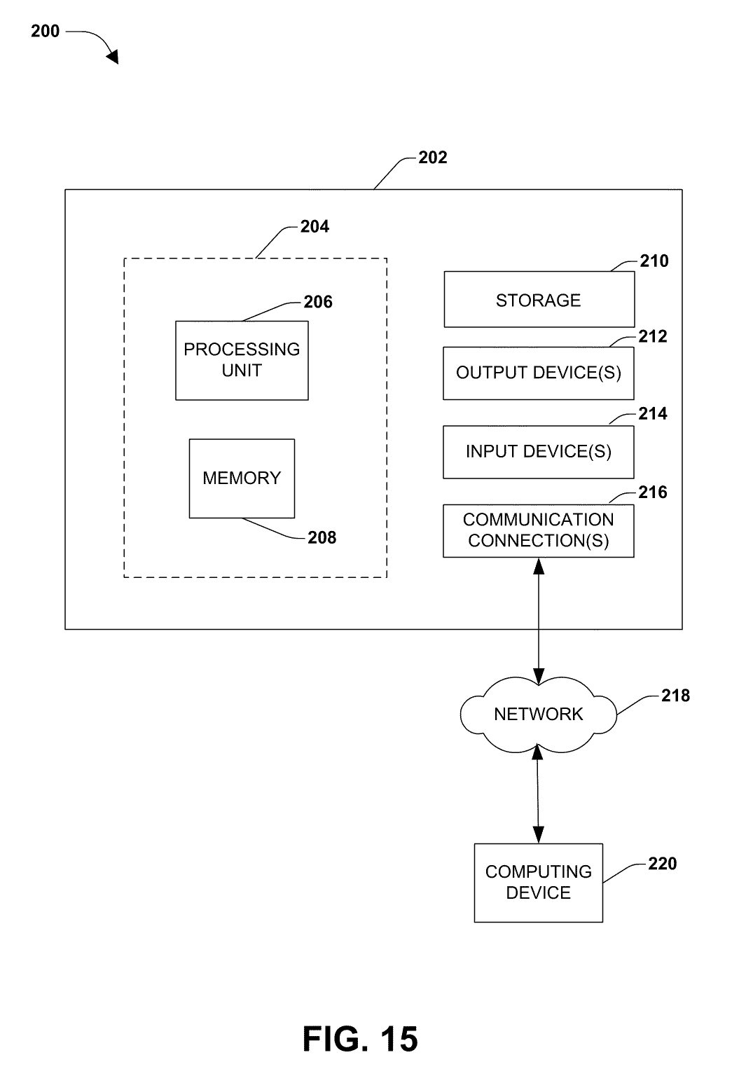

FIG. 15 and the following discussion provide a brief, general description of a suitable computing environment to implement embodiments of one or more of the provisions set forth herein. The operating environment of FIG. 15 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 15 illustrates an example of a system 200 comprising a computing device 202 configured to implement one or more embodiments provided herein. In one configuration, computing device 202 includes at least one processing unit 206 and memory 208. Depending on the exact configuration and type of computing device, memory 208 may be volatile (such as RAM, for example), non-volatile (such as ROM, flash memory, etc., for example) or some combination of the two. This configuration is illustrated in FIG. 15 by dashed line 204.

In other embodiments, device 202 may include additional features and/or functionality. For example, device 202 may also include additional storage (e.g., removable and/or non-removable) including, but not limited to, magnetic storage, optical storage, and the like. Such additional storage is illustrated in FIG. 15 by storage 210. In one embodiment, computer readable instructions to implement one or more embodiments provided herein may be in storage 210. Storage 210 may also store other computer readable instructions to implement an operating system, an application program, and the like. Computer readable instructions may be loaded in memory 208 for execution by processing unit 206, for example.

The term “computer readable media” as used herein includes computer storage media. Computer storage media includes volatile and nonvolatile, removable and non-removable media implemented in any method or technology for storage of information such as computer readable instructions or other data. Memory 208 and storage 210 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 202. Any such computer storage media may be part of device 202.

Device 202 may also include communication connection(s) 216 that allows device 202 to communicate with other devices. Communication connection(s) 216 may include, but is not limited to, a modem, a Network Interface Card (NIC), an integrated network interface, a radio frequency transmitter/receiver, an infrared port, a USB connection, or other interfaces for connecting computing device 202 to other computing devices. Communication connection(s) 216 may include a wired connection or a wireless connection. Communication connection(s) 216 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 202 may include input device(s) 214 such as keyboard, mouse, pen, voice input device, touch input device, infrared cameras, video input devices, and/or any other input device. Output device(s) 212 such as one or more displays, speakers, printers, and/or any other output device may also be included in device 202. Input device(s) 214 and output device(s) 212 may be connected to device 202 via a wired connection, wireless connection, or any combination thereof. In one embodiment, an input device or an output device from another computing device may be used as input device(s) 214 or output device(s) 212 for computing device 202.

Components of computing device 202 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 202 may be interconnected by a network. For example, memory 208 may be comprised of multiple physical memory units located in different physical locations interconnected by a network.

Those skilled in the art will realize that storage devices utilized to store computer readable instructions may be distributed across a network. For example, a computing device 220 accessible via network 218 may store computer readable instructions to implement one or more embodiments provided herein. Computing device 202 may access computing device 220 and download a part or all of the computer readable instructions for execution. Alternatively, computing device 202 may download pieces of the computer readable instructions, as needed, or some instructions may be executed at computing device 202 and some at computing device 220.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of generating an advertisement plan for a user of a computer having a processor and having access to an advertisement set comprising advertisements provided by respective advertisers, the method comprising:
executing upon the processor instructions configured to:
identify at least one potential route of the user;
for respective potential routes, identify along the potential route at least one advertisement opportunity where the user may have at least partial attention availability; and
for respective advertisement opportunities, select at least one advertisement from the advertisement set to be presented at the advertisement opportunity.

2. The method of claim 1:
the instructions configured to:
monitor the user to determine a completed route, and
for respective completed routes, store a route record in a user profile, the route record specifying the completed route; and
identifying the at least one potential route of the user comprising: selecting at least one completed route specified in at least one route record in the user profile.

3. The method of claim 1, identifying the at least one potential route of the user comprising:
detecting at least one route determinant, and
identifying at least one potential route that are correlated with the at least one route determinant.

4. The method of claim 3:
the position along the potential route associated with an attention type of the user, and
selecting the at least one advertisement to be presented at the advertisement opportunity comprising: selecting at least one advertisement that is compatible with the attention type of the user associated with the position along the potential route.

5. The method of claim 1, selecting the at least one advertisement to be presented at the advertisement opportunity comprising: selecting, to be presented at the advertisement opportunity, a first advertisement that relates to a second advertisement to be presented at an advertisement opportunity.

6. The method of claim 1, selecting the at least one advertisement to be presented at the advertisement opportunity comprising:
identifying at least one trait of the user, and
selecting advertisements targeted to the user based on the at least one trait.

7. The method of claim 1, selecting the at least one advertisement to be presented at the advertisement opportunity comprising:
detecting at least one advertisement opportunity factor relating the advertisement opportunity to at least one advertisement; and
selecting at least one advertisement that is related to the advertisement opportunity by the advertisement opportunity factor.

8. The method of claim 1, the computer utilizing a predictive function trained to predict at least one predictive user aspect selected from a set of predictive user aspects comprising:
potential routes selected by the user,
an attention availability of the user at an advertisement opportunity along a potential route, and
a user responsiveness to an advertisement presented at an advertisement opportunity.

9. The method of claim 1:
respective advertisements in the advertisement set having an advertisement action that is associated with an advertisement payment, and
selecting the at least one advertisement to be presented at the advertisement opportunity comprising: selecting advertisements that, for respective potential routes, maximize the advertisement payments associated with the advertisement actions of the advertisements.

10. The method of claim 9:
respective advertisements having an advertisement bid, and
selecting advertisements that, for respective potential routes, maximize the advertisement payments comprising:
for respective advertisement opportunities:
offering the advertisement opportunity to the advertisements;
receiving an advertisement bid from respective advertisements for the advertisement opportunity; and
selecting for the advertisement opportunity the advertisement offering a high advertisement bid.

11. The method of claim 10, the advertisement bid for at least one advertisement based on at least one advertising condition selected from a set of advertising aspects comprising:
an identified trait of the user;
a user relevance of the user correlated with the advertisement;
an attention type of the user at the advertisement opportunity;
an advertisement opportunity factor relating the advertisement to the advertisement opportunity;
a competitive advertising condition relating to selections of other advertisements for other advertising opportunities in the advertisement plan; and
a combinatorial advertising condition relating to selection of advertisements for at least two advertisement opportunities in the advertisement plan.

12. The method of claim 9, selecting for the advertisement opportunity the advertisement offering the high advertisement bid comprising: maximizing the mathematical formula:
V*(s)=max_{a∈A(s)}R(s,a)+Σ_{s′}T(s′,s,a)×V*(s′)
wherein:
s represents a state in a potential route corresponding to at least one of an advertisement opportunity and a location;
S represents a state set comprising the states s in the potential route;
V*(s) represents an expected cumulative value of state s, comprising expected advertisement revenue for the advertisement opportunity and future opportunities following state s;
A(s) represents a set of advertising actions for respective advertisements at a state s;
R(s,a) represents revenue for displaying a advertisement a at state s;
s′ represents a second state in a potential route that is accessible from a state s;
V*(s′) represents an expected cumulative value of state s′; and
T(s′,s,a) represents a transition probability of transitioning from a state s to a state s′ upon performing an advertising action a.

13. The method of claim 1, the instructions configured to:
monitor the user to determine:
a selected route among the potential routes, and
an arrival at an advertisement opportunity along the selected route; and
upon detecting the arrival at an advertisement opportunity along the selected route, present to the user the at least one advertisement selected to be presented at the advertisement opportunity.

14. The method of claim 13:
selecting the at least one advertisement to be presented at the advertisement opportunity based on at least one trait of the user, the at least one trait stored in a user profile; and
monitoring the user comprising: detecting an advertisement action by the user associated with an advertisement; and
the instructions configured, upon detecting the advertisement action, to:
identify at least one trait of the user based on the advertisement action, and
store the at least one trait in the user profile.

15. The method of claim 13:
respective advertisements associated with an advertisement payment, and
the instructions configured to, upon presenting an advertisement, compute the advertisement payment associated with the advertisement.

16. The method of claim 15:
the advertisement payments of respective advertisements associated with an advertisement action;
the instructions configured to, upon presenting the advertisement, monitor the user to detect the advertisement action associated with the advertisement; and
computing the advertisement payment comprising: upon detecting the advertisement action associated with the advertisement, compute the advertisement payment associated with the advertisement and the advertisement action.

17. The method of claim 16, computing the advertisement payment collected from advertiser i at state s according to the mathematical formula:
$${T}_{i} ( s , b ) = \frac{{V}_{- i}^{*} ( s , {b}_{- i} ) - {V}_{- i}^{*} ( s , {b}_{- i} \vert {π}^{*} ( s , b ) )}{{P}_{action} ( {b}_{i} )}$$
wherein:
s represents a state in a potential route corresponding to at least one of an advertisement opportunity and a location;
bᵢ represents an advertising bid received from advertiser i;
π*(s,b) represents a selected advertisement action computed for state s that maximizes the cumulative expected value in view of bids b;
V*₋ᵢ(s,b₋ᵢ) represents the cumulative expected value of all advertisers except advertiser i in state s, when advertiser i is excluded from advertisement opportunities;
V*₋ᵢ(s,b₋ᵢ|π*(s,b)) represents a cumulative expected value of all advertisers except advertiser i state s if the selected advertisement action is selected for the advertisement opportunity and advertiser I is excluded from future advertisement opportunities;
P_{action}(bᵢ) represents a probability that the user will undertake the action associated with bᵢ; and
Tᵢ(s,b) represents an advertisement payment to be collected from advertiser i at state s.

18. The method of claim 15, the instructions configured to, upon detecting the at least one advertisement action of the user, charge the advertiser the advertisement payment computed with respect to the advertisement and the advertisement action.

19. A system configured to generate an advertisement plan for a user of a computer having access to an advertisement set, the system comprising: a potential route identifying component configured to identify at least one potential route of the user;
an advertisement opportunity identifying component configured to, for respective potential routes, identify along the potential route at least one advertisement opportunity where the user may have at least partial attention availability; and
an advertisement selecting component configured to, for respective advertisement opportunities, select at least one advertisement from the advertisement set to be presented at the advertisement opportunity.

20. A computer-readable medium comprising processor-executable instructions that, when executed by a processor of a computer having access to an advertisement set comprising advertisements provided by respective advertisers and to a predictive function trained to correlate advertisements with a user relevance of a user of the computer during an advertisement opportunity, generate an advertisement plan for the user by:
monitoring the user to determine a completed route;
for respective completed routes, storing a route record in a user profile, the route record specifying the completed route;
detecting at least one route determinant;
identifying the at least one potential route of the user by performing at least one of:
selecting at least one completed route specified in at least one route record in the user profile, and
identifying at least one potential route that is correlated with the at least one route determinant;
for respective potential routes, identify along the potential route at least one advertisement opportunity where the user may have at least partial attention availability, and the advertisement opportunity associated with an attention type of the user;
for respective advertisement opportunities, selecting from the advertisement set, to be presented at the advertisement opportunity, at least one advertisement that is compatible with the attention type of the user associated with the position along the potential route, and the advertisement selected by:
identifying at least one trait of the user;
detecting at least one advertisement opportunity factor relating the advertisement opportunity to at least one advertisement; and
selecting the advertisement that:
is targeted to the user based on the at least one trait,
is related to the advertisement opportunity by the advertisement opportunity factor, and
has a high user relevance to the user during the advertisement opportunity according to the predictive function,
the advertisements selected to, for respective potential routes, maximize advertisement payments associated with advertisement actions of the advertisements;
monitoring the user to determine:
a selected route among the potential routes, and
an arrival at an advertisement opportunity along the selected route;
upon detecting the arrival at an advertisement opportunity along the selected route, presenting to the user the at least one advertisement selected to be presented at the advertisement opportunity;
monitoring the user to detect at least one advertisement action associated with at least one advertisement; and
upon detecting the advertisement action:
computing the advertisement payment associated with the advertisement and the advertisement action;
identifying at least one trait of the user based on the advertisement action; and
upon identifying the at least one trait, storing the at least one trait in the user profile.
